(19) United States
(12) Patent Application Publication
(10) Pub. No.: US 2016/0144269 A1
(43) Pub. Date: May 26, 2016

(54) CASINO CARD GAMES WITH OPTIONAL IN BETWEEN SIDE WAGER

(71) Applicant: AGS, LLC, Las Vegas, NV (US)

(72) Inventor: Ronald LaDuca, Cherry Hill, NJ (US)

(21) Appl. No.: 14/921,935

(22) Filed: Oct. 23, 2015

Related U.S. Application Data
(63) Continuation of application No. 14/280,545, filed on May 16, 2014, now abandoned.
Application No. 14/280,545 is a continuation-in-part of application No. 13/310,743, filed on Dec. 3, 2011, now abandoned.
Application No. 13/310,743 is a continuation-in-part of application No. 12/471,033, filed on May 22, 2009, now abandoned.

(51) Int. Cl. A63F 1/00; G07F 17/32

(52) U.S. Cl. CPC A63F 1/00; G07F 17/3288; G07F 17/3218; G07F 17/3209; G07F 17/3293; A63F 2001/003; A63F 2001/001; A63F 2001/005

(57) ABSTRACT

A method of playing a combined casino card game combining a standard casino card game with an optional In Between side bet that uses the same cards as played in the standard casino card game. A player makes an optional In Between side wager that the face value of at least one designated in between card falls in between or equals the face value of two designated end cards according to the “rank order” 2-3-4-5-6-7-8-9-10-J-Q-K-A. The casino card game bet and the optional In Between side bet are separate and do not affect the play of the standard casino card game. Preferred embodiments include the In Between side bet combined with casino Blackjack, Baccarat, and Texas Hold'em.

The present application is a continuation of U.S. patent application Ser. No. 14/280,545 filed May 16, 2014, which is a continuation-in-part of U.S. patent application Ser. No. 12/471,033 filed May 22, 2009 and Ser. No. 13/310,743 filed Dec. 3, 2011.

### FIELD OF THE INVENTION

The present invention relates to casino card games and particularly to a method of playing a combined casino card game combining a standard casino card game with an optional In Between side bet that uses a pair of end cards and an in between card designated from the same cards played in the standard casino card game without altering the play of the standard casino card game. In addition to the casino card game bet, a player may make a separate optional In Between side wager that the face value of at least one designated in between card falls in between two designated other cards according to the “rank order” 2-3-4-5-6-7-8-9-10-J-Q-K-A. If the in between card and two other cards all match, a triple match is paid out. The casino card game bet and the optional In Between side bet are separate and do not affect the play of the standard casino card game. Preferred embodiments include the In Between side bet combined with casino Blackjack, Baccarat, and Texas Hold'em.

### BACKGROUND OF THE INVENTION

Gamblers enjoy side betting in games to double the opportunity of winning and just to have another opportunity to gamble. But there is also a need to preserve the integrity of the game being played to maintain the original unadulterated use of cards and play so that the original card game is not altered by the side betting game. The present invention may be applied to any of a variety of casino card games including Blackjack, Bacarat, and Texas Hold'Em.

One of the most popular gambling card games is Blackjack, also known as Twenty-one or “21”, wherein a player plays against a dealer and the objective is to beat the dealer's hand by reaching a total point value closest to 21, without exceeding twenty-one and/or by having the dealer's point count go over twenty-one.

In Between, Acey-Deucy or Red Dog is an old gambling game wherein each player places a wager, and then two cards are dealt. The player has an option to place a further wager and a third card is dealt. If the rank value of the third card is between the rank values of the first two cards, the player wins both wagers.

Texas Hold'Em is a currently popular casino card game in which each players puts in their initial bets and a dealer will then deal two cards (referred to as pocket cards or hole cards) face down to each player. Once the cards are dealt, each player may look at the player's own cards. Then the players bet, raise, call, or fold their hands. The dealer burns a card, which means they deal it to one side and it is not used in play, and then deals three cards face down and turns the thee cards face up simultaneously which is called the flop. Then another round of betting, calling, raising, or folding takes place based on each player's poker hand made with the player's two down cards combined the three commonly shared “flop cards”. Next the dealer “burns” another card and then deals a “turn card” face up adjacent to the flop cards followed by another round of betting, calling, raising, or folding. Finally the dealer “burns” another card and then deals a “river card” face up next to the other community cards. A final round of betting, calling, raising or folding takes place and a winner is determined based on which player has the best five card poker hand out of the player's two down cards combined with the five up-facing

None of the prior art provides a combined optional In Between side betting game within a normally played casino card game with no alteration to the play and card dealing of the casino card game.

U.S. Pat. No. 6,182,969, issued Feb. 6, 2001 to Green, illustrates a blackjack wagering game in which an order card is dealt to determine the order of play. If the order card is a predetermined card, the dealer's hand is played before each player's hand, thereby giving an advantage to the players. In the preferred embodiment, the order card is a card that is dealt face up in the dealer's hand and the predetermined card is the ace of spades. A side wager is also disclosed in which a deck of cards used in the game has a plurality of card types. The card types are given a relative ranking. A side wager card is dealt during the game. If the side wager card is between two cards in a player's hand, then the player will win the side wager. In the preferred embodiment, the side wager card is the same card as the order card. The Green game relies on a play order determining card (preferably the ace of spades), which play order card determines whether the player or players play first (if the play order card is the ace) or the dealer plays first. Only after that is the in-between bet evaluated. The play order card may be a card dealt face-up to the dealer and may be the same as the dealer card used to determine whether or not the play order card has a value in-between the value of a player's two up cards. Alternately, a separate in-between card as a separate combined play order card and in-between card may be a separate card not dealt to a player or the dealer. The patent does not claim a blackjack game which uses just the normally dealt blackjack cards as a side bet wherein a player wins if the value of the dealer's up blackjack card is between the value of the player's two up blackjack cards. Furthermore, the patent does not provide for a player's two cards matching a dealer's up card or for any payout dependent on the variance in value of the dealer's up card (used as the in-between card) from the two player's up cards.

U.S. Patent Application #20060014577, published Jan. 19, 2006 by Snow, illustrates a Blackjack game with an award modifying feature. In preferred embodiments of the invention, an optional or mandatory side bet wager is made and the bonus award may be won on the basis of any defined event occurring in the play of the blackjack game, including, but not limited to, any of events in the player's 2-card hand, the dealer's up-card, the combination of the player's 2-card hand and the dealer's up-card, combinations of less than all the player's 2-card hand and the dealer's up-card, player's final hand, dealer's final hand, comparisons between player's initial 2-card hand and the dealer's initial 2-card hand (usually determined at the end of play or when the dealer's hand is revealed), differences between the player's final hand and the dealer's final hand (e.g., final point spread) and the like.

Two U.S. Pat. No. 6,296,251 issued Oct. 2, 2001 and U.S. Pat. No. 6,491,301 issued Dec. 10, 2002 to Webb, are for a method and apparatus for playing a card game including a variable payoff. A payout scheme for a card game is based on a numerical difference between a player's hand and a dealer's hand. The method is suited for card games wherein the numerical value of a player's hand affects the outcome of the game. Preferably, the game is a Blackjack derivative, wherein the payout based on the original wager is determined in accordance with an amount by which the player's hand exceeds the dealer's hand, without exceeding an upper limit.

U.S. Pat. No. 5,566,946, issued Oct. 22, 1996 to Parker, provides a Blackjack type game which is played with one or more conventional 52 card packs, with a dealer and one or more players, and with scoring according to the usual Blackjack conventions. But players have two kinds of bets, an Ante to place before play commences, and a Play bet to place after the first deal. The Ante bet remains fixed, but the Play bet may be increased during the course of play. All bets are forfeit to the dealer if a player loses, but if he wins different odds may be payable on the Ante and Play bets.

U.S. Pat. No. 6,341,778, issued Jan. 29, 2002 to Lee, shows a method for playing pointspread blackjack. The invention comprises a method for increasing the payout for the main wager of the game of blackjack or Twenty-One and/or for providing a side bet opportunity during the game of blackjack or Twenty-One which are based upon the point-spread between the players hand and the dealers hand. In one embodiment, a pointspread of 1, 2, 3, or 4 would result in 1.times., 1.5.times., 2.times., or 10.times. payout, respectively, of the side wager. In another embodiment, a pointspread of 1, 2, 3, or 4 would result in 1.times., 2.times., 3.times., or 5.times. payout, respectively, of a side bet. In another embodiment, a pointspread of 0, 1, 2, 3, or 4 would result in 0.5.times., 1.times., 1.5.times., 3.times., or 5.times. payout, respectively, of a side bet. The game allows for variations in the rules and for other types of side-betting opportunities while maintaining the excitement of a multiple pointspread payout at the resolution of the hand.

U.S. Pat. No. 6,776,416, issued Aug. 17, 2004 to Jackson, claims a no-bust blackjack-type game wherein odds or bonuses may be paid according to the relative difference between of the player's hand and the dealer's hand, or between point counts of the player's hand and the dealer's hand.

U.S. Pat. No. 7,066,465, issued Jun. 27, 2006 to Daines, indicates a side bet which may be implemented in any blackjack-style card game method which provides an opportunity to win a bet based on combinations of three cards which may be the player's first two cards and the dealer's first card. The player may win the side bet with certain combinations of cards having different winning payouts.

U.S. Pat. No. 6,598,879, issued Jul. 29, 2003 to Spur et al, provides a method of playing Blackjack wherein the player can wager that his hand will be broken by placing a side bet which is referred to as “Hit Insurance”. Two aspects of the invention are disclosed. The first aspect allows the player to place the side bet after he has seen his initial hand. If the player has 12 through 16 and the dealer has seven through ace as the upcard, the player is given the option of placing the side bet that he will be broken when he receives the hit card. In a first variation, the player places a side bet against a single hit and can renew the bet if he loses on the hit. In a second variation, the player places a side bet against multiple hits. In a second aspect of the invention, the player places a side bet before he is dealt any cards. In a first variation, the side bet loses if the dealer has 2 through 6 as the face card. In a second variation, the side bet pushes if the dealer has 2 through 6 as the up card. The second aspect of the invention may or may not have Blackjack insurance included in the side bet.

U.S. Pat. No. 6,547,246, issued Apr. 15, 2003 to Webb, puts forth a casino card game wherein a player makes a first elective wager and is provided with an opportunity to make a proposition wager. A dealer deals two cards, and the players can then wager whether a third card will fall between (MID) the first two cards or above (HI) or below (LOW) at least one of the first two cards. Preferably, the player betting the HI option or the LOW option will win if the third card is higher or lower, respectively, and of a same suit as at least one of the cards. The subsequent electing wager serves to direct the application of the first elective wager. With the proposition wager, the player wins if at least two of the three cards have a predetermined composite relationship based on suit and/or rank or three-card poker rankings.

U.S. Pat. No. 7,118,111, issued Oct. 10, 2006 to Altomare, concerns a method for playing a casino card game which utilize a standard deck of playing cards containing numbered cards 2-10 and face cards; jack, queen, king and ace, ace being high. A playing surface is used for multiple players and a dealer. Each player position has three card receiving dock areas and corresponding wager playing areas thereon and a bonus wagering area. Three wagers are placed and a first card is dealt face down to each player. A second card is dealt to each player face up and wherein one of the equal wagers can be withdrawn by the player. Each player has their face down card turned over by the dealer and is dealt a last card face up. If the last card ranks or falls between the displayed cards in the player's hand is then a winner and a pay-off is made depending on card spread sequence. A double down doubling of wager option is also available during card play in which all wagers still remaining on the playing surface are doubled and the player receives a replacement card for the first card dealt.

U.S. Patent Application #20070290443, published Dec. 20, 2007 by Lemberg et al, shows a wagering game involving card ranks wherein a player is dealt a card and the dealer is dealt a card, and a player wins if a player's card and the dealer's card are of equal rank, or if a player is dealt a second card that falls in rank between a player's card and a dealer's card. The player is given an option to exchange his or her initial card. The player is also given an option to double his or her wager before his second card is dealt. A bonus round can also be offered wherein a bonus card is dealt and the player wins a bonus if the bonus card falls between the dealer's card and the player's second card.

U.S. Patent Application #20050054411, published Mar. 10, 2005 by Hughs-Baird et al, concerns a gaming device having a high-low game wherein the game generates a masked target number or symbol that is formed from a plurality of component numbers or symbols. As the game is played, the gaming device generates and displays a first prediction number that relates to a first component number of the target number. If the generated first prediction number matches (i.e., is the same number as) the first component number of the target number, the first component number of the target number is revealed to the player and the player is provided an award based on the displayed first component number of the target number and at least one modifier. If the generated first prediction number does not match the first component number of the target number, the gaming device enables the player to input a prediction regarding the first component number wherein the prediction is based on the generated first prediction number. If the player's prediction is correct, the gaming device reveals the first component number of the target number and the player is provided an award based on the first component number of the target number. If the player's prediction is not correct, the gaming device reveals the first component number of the target number and proceeds as described above, to the next unrevealed component number, if any until each component number is revealed wherein a greater modifier is used for each provided award. The gaming device can incorporate any suitable wagering primary or base game. The gaming machine or device of the invention may include some or all of the features of conventional gaming machines or devices. The primary or base game may comprise any suitable reel-type game, card game, number game or other game of chance susceptible to representation in an electronic or electromechanical form which produces a random outcome based on probability data upon activation of the game from a wager made by the player. That is, different primary wagering games, such as video poker games, video blackjack games, video keno, video bingo or any other suitable primary or base game may be implemented into the invention.

U.S. Pat. No. 7,309,065, issued Dec. 18, 2007 to Yoseloff et al, describes a multi-player automated casino table card game platform enables play of casino table baccarat-type games according to rules effected through a processor. Rules may include games similar to Baccarat, Mini Baccarat or alternately Blackjack, with an optional side bet on a point spread between the player and bank hands.

U.S. Pat. No. 6,789,801, issued Sep. 14, 2004 to Snow, discloses a casino game that can be played on a gaming table with a base game wager and an optional side bet bonus wager. The game is preferably a Baccarat derivative or Mini-Baccarat derivative, or alternately Blackjack, wherein there is at least one potential payout on the side bet bonus wager in addition to normal play of the game. One payoff for wagering on a winning hand in the side bet bonus wager (either the player's hand or a banker's hand) is based upon the hand that is wagered upon having a natural (two-card) 8-count or 9-count. A second potential payout on the side bet bonus wager is based upon the size of the difference between player hand point count and dealer hand point counts. Alternatively, the bonus hand pays only for the highest payout.

What is needed is an optionally bet In Between game combined with any of a variety of other casino card games, wherein the other casino card game play in not altered by the optional In Between bet and the same cards used in the casino card game are also used in the In Between side bet.

### SUMMARY OF THE INVENTION

An object of the present invention is to provide an optional bet In Between game combined with any of a variety of other casino card games, wherein the other casino card game play in not altered by the optional In Between bet and the In Between optional side bet uses three of the same cards used in the playing of the casino card game.

In brief, in the present invention a simultaneous optional bet In Between game is played with any of a variety of other standard casino card games using selected cards played in the standard casino card game for the In Between cards without interfering with the play of the standard casino card game.

The optional bet In Between game may be integrated into a new combined casino card game with the In Between optional bet game used in a standard casino blackjack or twenty-one game, allowing a player to make an optional In Between side wager that the dealer's first upcard falls in between the player's first two dealt up cards (cards dealt in the standard casino blackjack game), according to the “rank order” 2-3-4-5-6-7-8-9-10-J-Q-K-A, and is lost otherwise. The only exception to this rule is if the player is initially dealt two up cards of the same rank and the dealer's dealt face up card is also of the same rank, which results in a triple match payout. The Blackjack bet and the optional In Between side bet are separate and do not affect the play of the standard casino blackjack game.

The optional bet In Between game may be integrated into a new combined casino card game with the In Between optional bet game used in a standard casino Baccarat game, allowing a player to make an optional In Between side wager that the first up card of the bank hand is in between the first two up cards of the player hand after the three cards have all been turned face up in the standard play according to the rules of Baccarat.

The optional bet In Between game may be integrated into a new combined casino card game with the In Between optional bet game used in a standard casino Texas Hold'Em game, allowing a player to make on optional In Between side wager that the middle card of the three flop cards is in between the two end cards of the three flop cards after the three flop cards have been flopped in standard play of the Texas Hold'Em game.

An advantage of the present invention is that it provides a new combined casino card game allowing an optional In Between side bet for a player during the play of a standard casino card game using the cards normally dealt in the standard casino card game and without affecting the play of the standard casino card game.

### DESCRIPTION OF THE DRAWINGS

FIG. 1 is a plan view of a casino card game playing table layout for a standard casino blackjack card game played in combination with an optional casino card game of In Between in a side bet showing the player layouts and pay tables facing the players and the dealer layout and pay tables facing the dealer on the other side of the playing table from the players;

FIG. 2 is an exploded plan view showing the Blackjack payout, dealer play limits, insurance bet with odds, and indication of the three In Between cards shown in empty elongated curved boxes facing the players on the layout of FIG. 1 for the standard casino blackjack card game played in combination with an optional casino card game of In Between of the present invention;

FIG. 3 is an exploded plan view showing a player layout with demarked player betting locations for the Blackjack bets and the optional In Between bets and the In Between bet payout table on the casino card table of FIG. 1 for the standard casino blackjack card game played in combination with an optional casino card game of In Between of the present invention;

FIG. 4 is an elevational view of a simulation of the playing table layout of the standard casino blackjack card game played in combination with an optional casino card game of In Between of the present invention shown on a screen of an electronic simulation device showing a simulation of the player layouts and payout tables and the dealer layout and pay table, a dealer card layout and a player card layout showing the Blackjack cards used for the Blackjack game and demarking which of the three Blackjack cards are used for the optional In Between bet, and the control areas for the player to activate in making choices during the play of the Blackjack game;

FIG. 5 is an elevational view of a simulation of the playing table layout of the standard casino blackjack card game played in combination with an optional casino card game of In Between of the present invention shown on a screen of a computer device showing a simulation of showing a simulation of the player layouts and the optional In Between bet payout table, and the dealer layout and pay table, a dealer card layout and a player card layout showing the Blackjack cards used for the Blackjack game and demarking which of the three Blackjack cards are used for the optional In Between bet, and the control areas for the player to activate in making choices during the play of the Blackjack game;

FIG. 6 is an elevational view of a simulation of a player layout for the playing table layout of the standard casino blackjack card game played in combination with an optional casino card game of In Between of the present invention shown on a touch screen of a wireless device showing a simulation of a player casino table layout and pay table and showing a dealer card layout and a player card layout showing the Blackjack cards used for the Blackjack game and demarking which of the three Blackjack cards are used for the optional In Between bet, and the control areas for the player to touch to activate in making choices during the play of the Blackjack game.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

The present invention provides a method of playing a standard casino card game in combination with an optional side bet for a casino card game of In Between, the optional side bet paid out on designated cards used in playing the standard casino card game without affecting normal play of the standard casino card game, the method comprising the following steps:

a) a first step of providing a standard deck of playing cards used for playing a standard casino card game;

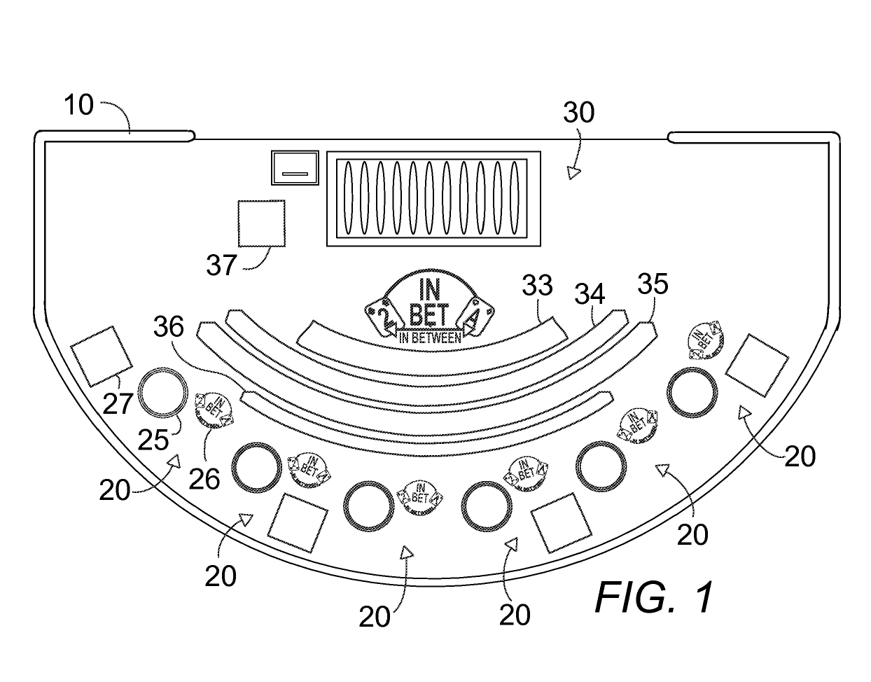

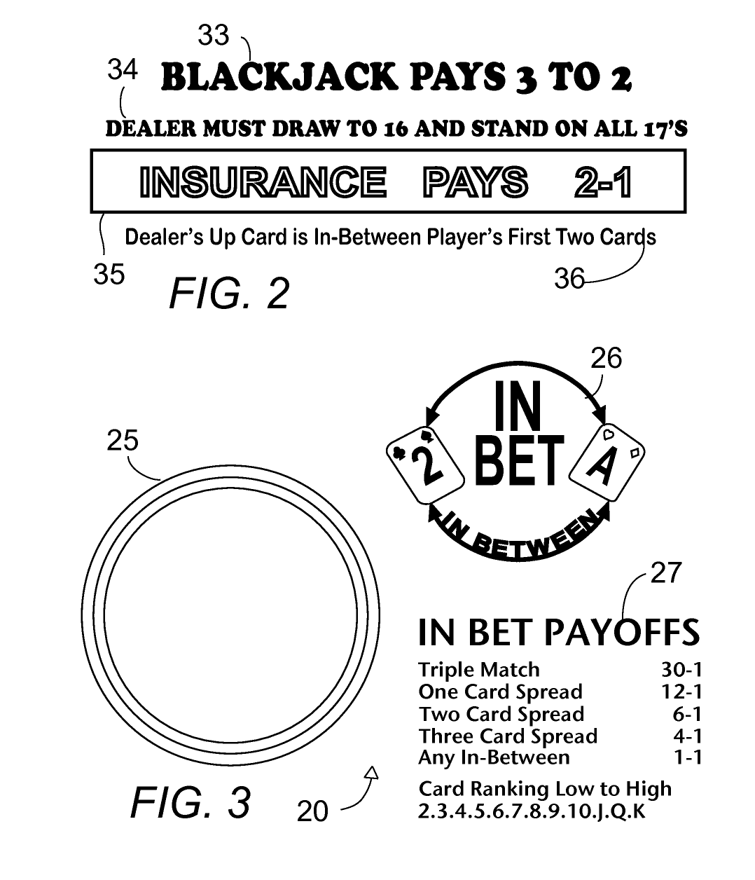

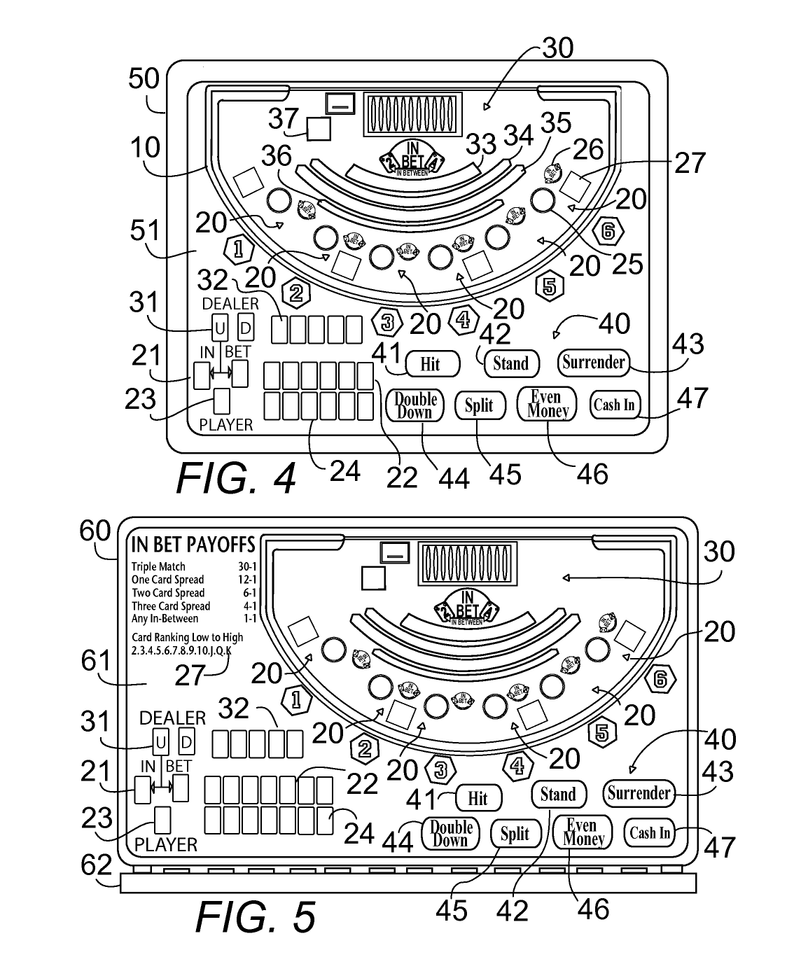

b) a second step of providing a playing layout 10 on an actual casino gaming table, as shown in FIG. 1 or a simulated layout 10 or player position 20, as shown in FIGS. 4-6, the layout 10 comprising: at least one first betting location 25 for at least one player in a player position 20 at and at least one bet payout odds indication 33 and 35, as shown in FIG. 2, for playing the standard casino card game; a demarcation 36 of which card used in the standard casino card game is also designated as the in between card for the In Between optional side bet and which two cards used in the standard casino card game are also designated as the two end cards for the In Between optional side bet without altering the play of the standard casino card game; at least one In Between casino card game optional second betting location 26; and at least one In Between optional side bet payout table 27, as shown in FIG. 3, for an optional In Between side bet paid out on the designated In Between cards used in the normal play of the standard casino card game, the In Between side bet payout table 27 for the players facing the players and the same side bet payout table 37 for the dealer facing the dealer, displaying payout odds based on a face value of the at least one designated in between card relative to the face values of the two designated end cards, and how closely the face value of the designated in between card falls in between the face values of the at least two designated end cards according to the at least one In Between payout table;

c) a third step of placing at least one standard bet on the standard casino card game in the at least one first betting location 25;

d) a fourth step of placing an optional In Between side bet in the at least one second betting location 26;

e) a fifth step of dealing cards to each player and cards to the dealer for playing the standard casino card game;

f) a sixth step of proceeding with the play of the standard casino card game;

g) a seventh step of paying out the optional In Between side bet when the designated In Between cards are revealed during normal play of the standard casino card game after the at least one designated in between card and the at least two designated end cards have been turned face up in the standard play according to the rules of the standard casino card game, cashing out each of the optional bets made on the In Between side bets according to the following payout: each of the number of players placing bets in the optional game of In Between lose the In Between bet if a face value of the at least one designated in between card is not in between or equal to the face values of the at least two designated end cards, and each of the number of players placing bets in the optional game of In Between win the In Between side bet if the face value of the at least one designated in between card is in between or equal to the face values of the at least two designated end cards, so that the In Between winning bets in the optional In Between game are paid out according to the payout odds indicated by the at least one payout table 27 for the In Between optional side bet, including the In Between payout odds of twelve to one for a one card spread, six to one for a two card spread, and four to one for a three card spread;

h) an eighth step of playing out the standard casino card game using all of the cards dealt in the standard casino card game according to the rules of the standard casino card game including the at least one designated in between card and the two designated end cards used in the standard play of the standard casino card game; and cashing out the standard casino card game bets, thereby playing a combined casino card game comprising a standard casino card game combined with an In Between casino card game optional side bet using only the cards dealt for the standard casino card game and conventional play for the standard card game.

The seventh step further comprises cashing out the In Between optional side bet comprises using the following set of odds on the payout table 27 of the optional In Between side bet: thirty to one for an equal face value, twelve to one for a one card face value spread, six to one for a two card face value spread, four to one for a three card face value spread, and one to one for all other face value spreads.

The seventh step further comprises evaluating the face value of the at least one in between card compared with the face value of the at least two end cards in the In Between optional side bet comprises using the face value rank order 2-3-4-5-6-7-8-9-10-J-Q-K-A.

In FIGS. 1-3, the second step of the combined casino card game may comprise providing the playing layout 10 on a casino gaming table having at least one player layout 20 for at least one player sitting at the casino gaming table having a dealer layout 30 for a dealer at the casino gaming table to play the combined casino card game according to the method of the present invention.

The second step of the combined casino card game may comprise providing the playing layout on any of a variety of simulation devices for at least one player to play the combined casino card game according to the method of the present invention.

The second step of the combined casino card game may comprise providing the playing layout on a mechanical simulation device, such as an imprinted roll out or fold up layout similar to the casino gaming table layout 10 of FIG. 1, sold as a home game or party game, for at least one player to play the combined casino card game according to the method of the present invention.

In FIGS. 4 and 5, the second step of the combined casino card game comprises providing the playing layout on an electronic simulation device 50 and 60, having an electronic viewing screen 51 and 61 respectively showing the playing layout 10 for at least one player and further comprises providing a plurality of control areas 40 on the electronic viewing screen for the at least one player to activate to control the electronic simulation device in making player choices during the play of the combined casino card game according to the method of the present invention.

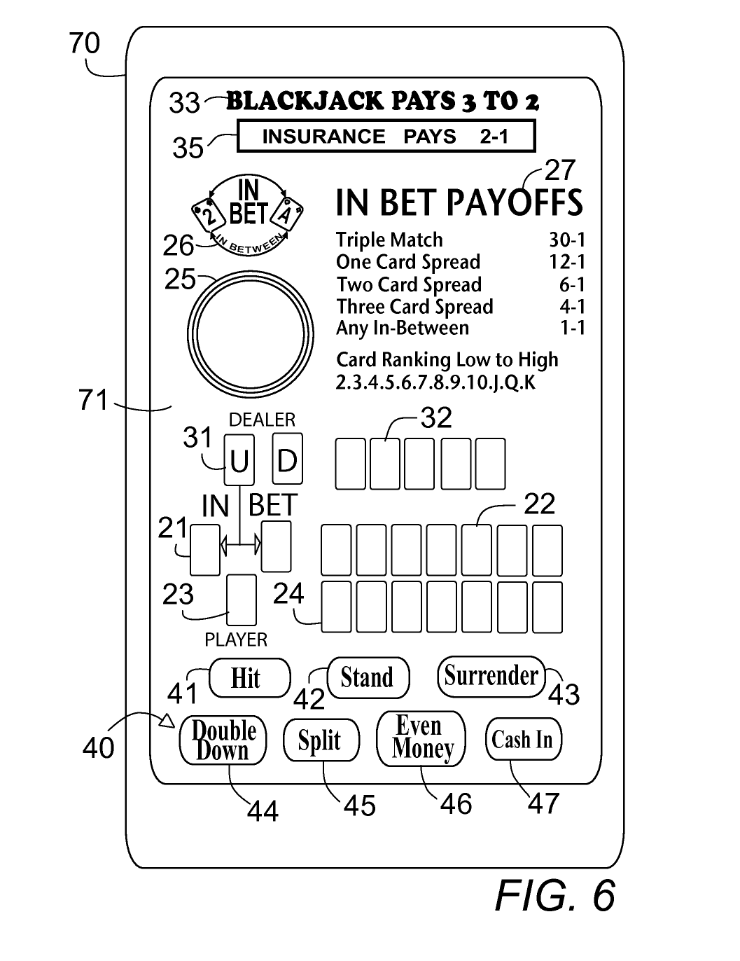

In FIG. 6, the second step of the combined casino card game may comprise providing the playing layout on a handheld electronic simulation device 70 such as a smart phone or tablet, the handheld electronic simulation device comprising a touch screen 71 as a means for interacting with the handheld electronic simulation device 70, the at least one player touching the screen to control the electronic simulation device in making player choices during the play of the combined casino card game according to the method of the present invention.

In FIGS. 4-6, a simulation of the playing table layout 10 of the standard casino Blackjack card game played in combination with an optional casino card game of In Between of the present invention shown on a screen 51 of any electronic simulation device 50, in FIG. 4, or a screen 61 of a computer 60, in FIG. 5, or a touch screen 71 of a hand-held device 70 such as a smart phone or tablet, in FIG. 6, showing a simulation of the player layouts 20, numbered 1-6 for identification in the electronic play in FIGS. 4 and 5 but only a single player position on the handheld device 70 of FIG. 6, and payout tables 27 and the dealer layout 30 and pay table 37. A dealer card layout shows electronic simulations of the two Blackjack dealer's dealt cards 31 one up card (U) and one down card (D) and locations for the simulated indications of additional dealer “hit” cards 32 if needed, and a player card layout showing the Blackjack cards used for the Blackjack game, including electronic simulations of the two player dealt cards 21 and any player“hit” cards 22 and a possible “double down” card 23 and any necessary “split” cards 24 and demarking by the IN BET line and double arrow which of the three Blackjack cards are used for the optional In Between bet, and the control areas 40 for the player to activate in making choices during the play of the Blackjack game, including Hit 41, Stand 42, Surrender 43, Double Down 44, Split 45, Even Money 46, and Cash In 47 to be selected electronically by the player for communication with the electronic device about the player choices.

The second step of the combined casino card game may comprise providing the playing layout on an electronic device having a connection to a remote network to play the combined casino card game according to the method of the present invention.

The second step of the combined casino card game may comprise providing the playing layout on an electronic device having a connection to a remote network to play the combined casino card game according to the method of the present invention on an electronic device taken from the list of electronic devices including a computer, a handheld device, a telephonic device, an entertainment device, and a gaming device.

In FIGS. 1-6, the standard casino card game may comprise standard casino Blackjack played in combination with an optional casino card game of In Between in a side bet using the same Blackjack cards as dealt for the Blackjack game and conventional play for the game of Blackjack, and wherein:

the second step of providing a playing layout comprises the In Between optional side bet demarcation designating the first up card dealt to the dealer in the Blackjack casino card game as the at least one designated in between card for the In Between optional side bet, and designating the first two cards dealt to a Blackjack player who has placed an optional In Between side bet as the designated end cards for the In Between optional side bet, the optional In Between side bet outcome being determined by comparing a face value of the first up card of the Blackjack dealer, the designated in between card, compared with the a face value of the two cards dealt to the Blackjack player, the designated end cards;

the seventh step of paying out the optional In Between side bet comprises, after the first up card of the dealer, the designated in between card, and the first two dealt cards of each player placing the optional In Between side bet, the designate end cards, have all been turned face up in the standard play according to the rules of blackjack, cashing out each of the optional bets on the game of In Between according to the following payout: each of the number of players placing bets in the optional game of In Between lose the In Between bet if a face value of the first up card of the dealer is not in between or equal to the face values of the first two up dealt cards of the player, and each of the number of players placing bets in the optional game of In Between win the In Between bet if the face value of the first up card of the dealer is in between or equal to the face values of the first two up dealt cards of the player, so that the In Between winning bets in the optional In Between game are paid out according to a set of odds in the In Between payout table established for the In Between optional side betting steps of the combined casino card game so that the In Between winning bets in the optional In Between game are paid out according to the payout odds indicated by the at least one payout table for the In Between optional side bet, the odds comprising: thirty to one for an equal face value, twelve to one for a one card face value spread, six to one for a two card face value spread, four to one for a three card face value spread, and one to one for all other face value spreads;

the eighth step comprises playing out the Blackjack game using all of the cards dealt in the Blackjack game according to the rules of the standard casino blackjack game including using the first two dealt cards of each player and the first up card of the dealer as played in a standard Blackjack casino card game, thereby providing a method of playing a combined card game of standard casino Blackjack and an optional casino card game of In Between in a side bet using the same Blackjack cards as dealt for the Blackjack game and conventional play for the game of Blackjack according to the method of the present invention.

The first step of providing at least one standard deck of playing cards may comprise providing any of the numbers of standard decks of playing cards taken from the list of decks including one deck, two decks, four decks, six decks, and eight decks for the combined Blackjack casino card game and optional In Between side bet game.

The standard casino card game may alternately comprise a standard casino Baccarat card game played in combination with an optional casino card game of In Between in a side bet using the same Baccarat cards as dealt for the Baccarat card game and conventional play for the game of Baccarat, and wherein:

the second step of providing a playing layout comprises the In Between optional side bet demarcation designating the first up card of the bank hand in the Baccarat game as the at least one designated in between card and designating the first two up cards of the player hand in the Baccarat game as the at least two designated end cards to be evaluated with the first up card of the bank hand to determine if a face value of the first up card of the bank hand falls between or is equal to the face value of the first two up cards of the player hand;

the seventh step of paying out the optional In Between side bet comprises: after the first up card of the bank hand and the first two up cards of the player hand have all been turned face up in the standard play according to the rules of Baccarat, cashing out each of the optional bets on the game of In Between according to the following payout: each of the number of players placing bets in the optional game of In Between lose the In Between bet if a face value of the first up card of the bank hand is not in between or equal to the face values of the first two up cards of the player hand, and each of the number of players placing bets in the optional game of In Between win the In Between bet if the face value of the first up card of the bank hand is in between or equal to the face values of the first two up cards of the player hand, so that the In Between winning bets in the optional In Between game are paid out according to payout odds indicated by the at least one payout table for the In Between optional side bet, the odds comprising: thirty to one for an equal face value, twelve to one for a one card face value spread, six to one for a two card face value spread, four to one for a three card face value spread, and one to one for all other face value spreads;

the eighth step comprises playing out the Baccarat game using all of the cards dealt in the Baccarat game according to the rules of the standard casino Baccarat game including the first two up cards of the player hand and the first up card of the bank hand played according to the Baccarat rules, playing out the Baccarat hand according to conventional play for a standard casino Baccarat game, thereby providing a method of playing a combined card game of standard casino Baccarat and an optional casino card game of In Between in a side bet using the same Baccarat cards as dealt for the Baccarat game and conventional play for the game of Baccarat according to the method of the present invention.

The standard casino card game may alternately comprise standard casino Texas Hold'em card game played in combination with an optional casino card game of In Between in a side bet using the same Texas Hold'em cards as dealt for the Texas Hold'em card game and conventional play for the game of Texas Hold'em, and wherein:

the second step of providing a playing layout comprises the In Between optional side bet demarcation designating the middle flop card as the at least one designated in between card and designating the two end flop cards as the at least two designated end cards to be evaluated with the middle flop card to determine if a face value of the middle flop card falls between or is equal to the face value of the two end flop cards;

the seventh step of paying out the optional In Between side bet comprises: after the flop cards have been turned face up in the standard play according to the rules of Texas Hold'em, cashing out each of the optional In Between side bets according to the following payout: each of the number of players placing bets in the optional side bet of In Between lose the In Between bet if a face value of the middle flop card is not in between or equal to the face values of the two end flop cards, and each of the number of players placing bets in the optional game of In Between win the In Between bet if the face value of the middle flop card is in between or equal to the face values of the end flop cards, so that the In Between winning bets in the optional In Between game are paid out according to a set of odds in the In Between payout table established for the In Between optional side betting steps of the combined casino card game so that the In Between winning bets in the optional In Between game are paid out according to the payout odds indicated by the at least one payout table for the In Between optional side bet, the odds comprising: thirty to one for an equal face value, twelve to one for a one card face value spread, six to one for a two card face value spread, four to one for a three card face value spread, and one to one for all other face value spreads;

the eighth step comprises playing out the Texas Hold'em casino card game using all of the cards dealt in the Texas Hold'em game according to the rules of the standard casino Texas Hold'em game including the flop cards, playing out the Texas Hold'em hand according to conventional play for a standard casino Texas Hold'em card game, thereby providing a method of playing a combined card game of standard casino Texas Hold'em and an optional casino card game of In Between in a side bet using the same Texas Hold'em cards as dealt for the Texas Hold'em game and conventional play for the game of Texas Hold'em according to the method of the present invention.

In use, in the method of the present invention, to begin each round, the players or players must place their standard casino card game bets in one location on the table and the optional In Between side bet if desired in another location on the table. The dealer proceeds to deal the cards for the standard casino card game and the standard casino card game is played until all of the designated in between cards are displayed face up on the table in the course of the playing of the standard casino card game. Then, the optional In Between bets are paid out according to the payout table and the remainder of the standard casino card game is played out and paid out.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A method of playing a standard casino card game in combination with an optional side bet for a casino card game of In Between, the optional side bet paid out on designated cards used in playing the standard casino card game without affecting normal play of the standard casino card game, the method comprising the following steps:
a) a first step of providing a standard deck of playing cards used for playing a standard casino card game;
b) a second step of providing a playing layout comprising: at least one first betting location for at least one player and at least one bet payout odds indication for playing the standard casino card game; a demarcation of which card used in the standard casino card game is also designated as the in between card for the In Between optional side bet and which two cards used in the standard casino card game are also designated as the two end cards for the In Between optional side bet without altering the play of the standard casino card game; at least one In Between casino card game optional second betting location; and at least one In Between optional side bet payout table for an optional In Between side bet paid out on the designated In Between cards used in the normal play of the standard casino card game, the In Between side bet payout table displaying payout odds based on a face value of the at least one designated in between card relative to the face values of the two designated end cards, and how closely the face value of the designated in between card falls in between the face values of the at least two designated end cards according to the at least one In Between payout table;
c) a third step of placing at least one standard bet on the standard casino card game in the at least one first betting location;
d) a fourth step of placing an optional In Between side bet in the at least one second betting location;
e) a fifth step of dealing cards to each player and cards to the dealer for playing the standard casino card game;
f) a sixth step of proceeding with the play of the standard casino card game;
g) a seventh step of paying out the optional In Between side bet when the designated In Between cards are revealed during normal play of the standard casino card game after the at least one designated in between card and the at least two designated end cards have been turned face up in the standard play according to the rules of the standard casino card game, cashing out each of the optional bets made on the In Between side bets according to the following payout: each of the number of players placing bets in the optional game of In Between lose the In Between bet if a face value of the at least one designated in between card is not in between or equal to the face values of the at least two designated end cards, and each of the number of players placing bets in the optional game of In Between win the In Between side bet if the face value of the at least one designated in between card is in between or equal to the face values of the at least two designated end cards, so that the In Between winning bets in the optional In Between game are paid out according to the payout odds indicated by the at least one payout table for the In Between optional side bet, including the In Between payout odds of twelve to one for a one card spread, six to one for a two card spread, and four to one for a three card spread;
h) an eighth step of playing out the standard casino card game using all of the cards dealt in the standard casino card game according to the rules of the standard casino card game including the at least one designated in between card and the two designated end cards used in the standard play of the standard casino card game; and cashing out the standard casino card game bets, thereby playing a combined casino card game comprising a standard casino card game combined with an In Between casino card game optional side bet using only the cards dealt for the standard casino card game and conventional play for the standard card game.

2. The method of claim 1 wherein the seventh step comprises cashing out the In Between optional side bet comprises using the following set of odds for payout of the optional In Between side bet: thirty to one for an equal face value, twelve to one for a one card face value spread, six to one for a two card face value spread, four to one for a three card face value spread, and one to one for all other face value spreads.

3. The method of claim 1 wherein the seventh step comprises evaluating the face value of the at least one in between card compared with the face value of the at least two end cards in the In Between optional side bet comprises using the face value rank order 2-3-4-5-6-7-8-9-10-J-Q-K-A.

4. The method of claim 1 wherein the second step of the combined casino card game comprises providing the playing layout on a casino gaming table having at least one player layout for at least one player sitting at the casino gaming table having a dealer layout for a dealer at the casino gaming table to play the combined casino card game according to the method of the present invention.

5. The method of claim 1 wherein the second step of the combined casino card game comprises providing the playing layout on a simulation device for at least one player to play the combined casino card game according to the method of the present invention.

6. The method of claim 5 wherein the second step of the combined casino card game comprises providing the playing layout on a mechanical simulation device for at least one player to play the combined casino card game according to the method of the present invention.

7. The method of claim 5 wherein the second step of the combined casino card game comprises providing the playing layout on an electronic simulation device having an electronic viewing screen of the playing layout for at least one player and further comprises providing a plurality of control areas on the electronic viewing screen for the at least one player to activate to control the electronic simulation device in making player choices during the play of the combined casino card game according to the method of the present invention.

8. The method of claim 5 wherein the second step of the combined casino card game comprises providing the playing layout on a handheld electronic simulation device, the handheld electronic simulation device comprising a touch screen means for interacting with the handheld electronic simulation device, the at least one player touching the screen to control the electronic simulation device in making player choices during the play of the combined casino card game according to the method of the present invention.

9. The method of claim 5 wherein the second step of the combined casino card game comprises providing the playing layout on an electronic device having a connection to a remote network to play the combined casino card game according to the method of the present invention.

10. The method of claim 5 wherein the second step of the combined casino card game comprises providing the playing layout on an electronic device having a connection to a remote network to play the combined casino card game according to the method of the present invention on an electronic device taken from the list of electronic devices including a computer, a handheld device, a telephonic device, an entertainment device, a gaming device, and a television device.

11. The method of claim 1 wherein the standard casino card game comprises standard casino blackjack played in combination with an optional casino card game of In Between in a side bet using the same blackjack cards as dealt for the blackjack game and conventional play for the game of blackjack, and wherein:
the second step of providing a playing layout comprises the In Between optional side bet demarcation designating the first up card dealt to the dealer in the Blackjack casino card game as the at least one designated in between card for the In Between optional side bet, and designating the first two cards dealt to a Blackjack player who has placed an optional In Between side bet as the designated end cards for the In Between optional side bet, the optional In Between side bet outcome being determined by comparing a face value of the first up card of the Blackjack dealer, the designated in between card, compared with the a face value of the two cards dealt to the Blackjack player, the designated end cards;
the seventh step of paying out the optional In Between side bet comprises, after the first up card of the dealer, the designated in between card, and the first two dealt cards of each player placing the optional In Between side bet, the designate end cards, have all been turned face up in the standard play according to the rules of blackjack, cashing out each of the optional bets on the game of In Between according to the following payout: each of the number of players placing bets in the optional game of In Between lose the In Between bet if a face value of the first up card of the dealer is not in between or equal to the face values of the first two up dealt cards of the player, and each of the number of players placing bets in the optional game of In Between win the In Between bet if the face value of the first up card of the dealer is in between or equal to the face values of the first two up dealt cards of the player, so that the In Between winning bets in the optional In Between game are paid out according to a set of odds in the In Between payout table established for the In Between optional side betting steps of the combined casino card game so that the In Between winning bets in the optional In Between game are paid out according to the payout odds indicated by the at least one payout table for the In Between optional side bet, the odds comprising: thirty to one for an equal face value, twelve to one for a one card face value spread, six to one for a two card face value spread, four to one for a three card face value spread, and one to one for all other face value spreads;
the eighth step comprises playing out the Blackjack game using all of the cards dealt in the Blackjack game according to the rules of the standard casino blackjack game including using the first two dealt cards of each player and the first up card of the dealer as played in a standard Blackjack casino card game, thereby providing a method of playing a combined card game of standard casino Blackjack and an optional casino card game of In Between in a side bet using the same Blackjack cards as dealt for the Blackjack game and conventional play for the game of Blackjack according to the method of the present invention.

12. The method of claim 11 wherein the first step of providing at least one standard deck of playing cards comprises providing any of the numbers of standard decks of playing cards taken from the list of decks including one deck, two decks, four decks, six decks, and eight decks.

13. The method of claim 1 wherein the standard casino card game comprises standard casino Baccarat card game played in combination with an optional casino card game of In Between in a side bet using the same Baccarat cards as dealt for the Baccarat card game and conventional play for the game of Baccarat, and wherein:
the second step of providing a playing layout comprises the In Between optional side bet demarcation designating the first up card of the bank hand in the Baccarat game as the at least one designated in between card and designating the first two up cards of the player hand in the Baccarat game as the at least two designated end cards to be evaluated with the first up card of the bank hand to determine if a face value of the first up card of the bank hand falls between or is equal to the face value of the first two up cards of the player hand;
the seventh step of paying out the optional In Between side bet comprises: after the first up card of the bank hand and the first two up cards of the player hand have all been turned face up in the standard play according to the rules of Baccarat, cashing out each of the optional bets on the game of In Between according to the following payout: each of the number of players placing bets in the optional game of In Between lose the In Between bet if a face value of the first up card of the bank hand is not in between or equal to the face values of the first two up cards of the player hand, and each of the number of players placing bets in the optional game of In Between win the In Between bet if the face value of the first up card of the bank hand is in between or equal to the face values of the first two up cards of the player hand, so that the In Between winning bets in the optional In Between game are paid out according to payout odds indicated by the at least one payout table for the In Between optional side bet, the odds comprising: thirty to one for an equal face value, twelve to one for a one card face value spread, six to one for a two card face value spread, four to one for a three card face value spread, and one to one for all other face value spreads;
the eighth step comprises playing out the Baccarat game using all of the cards dealt in the Baccarat game according to the rules of the standard casino Baccarat game including the first two up cards of the player hand and the first up card of the bank hand played according to the Baccarat rules, playing out the Baccarat hand according to conventional play for a standard casino Baccarat game, thereby providing a method of playing a combined card game of standard casino Baccarat and an optional casino card game of In Between in a side bet using the same Baccarat cards as dealt for the Baccarat game and conventional play for the game of Baccarat according to the method of the present invention.

14. The method of claim 1 wherein the standard casino card game comprises standard casino Texas Hold'em card game played in combination with an optional casino card game of In Between in a side bet using the same Texas Hold'em cards as dealt for the Texas Hold'em card game and conventional play for the game of Texas Hold'em, and wherein:
the second step of providing a playing layout comprises the In Between optional side bet demarcation designating the middle flop card as the at least one designated in between card and designating the two end flop cards as the at least two designated end cards to be evaluated with the middle flop card to determine if a face value of the middle flop card falls between or is equal to the face value of the two end flop cards;
the seventh step of paying out the optional In Between side bet comprises: after the flop cards have been turned face up in the standard play according to the rules of Texas Hold'em, cashing out each of the optional In Between side bets according to the following payout: each of the number of players placing bets in the optional side bet of In Between lose the In Between bet if a face value of the middle flop card is not in between or equal to the face values of the two end flop cards, and each of the number of players placing bets in the optional game of In Between win the In Between bet if the face value of the middle flop card is in between or equal to the face values of the end flop cards, so that the In Between winning bets in the optional In Between game are paid out according to a set of odds in the In Between payout table established for the In Between optional side betting steps of the combined casino card game so that the In Between winning bets in the optional In Between game are paid out according to the payout odds indicated by the at least one payout table for the In Between optional side bet, the odds comprising: thirty to one for an equal face value, twelve to one for a one card face value spread, six to one for a two card face value spread, four to one for a three card face value spread, and one to one for all other face value spreads;
the eighth step comprises playing out the Texas Hold'em casino card game using all of the cards dealt in the Texas Hold'em game according to the rules of the standard casino Texas Hold'em game including the flop cards, playing out the Texas Hold'em hand according to conventional play for a standard casino Texas Hold'em card game, thereby providing a method of playing a combined card game of standard casino Texas Hold'em and an optional casino card game of In Between in a side bet using the same Texas Hold'em cards as dealt for the Texas Hold'em game and conventional play for the game of Texas Hold'em according to the method of the present invention.
